(19) United States
(12) Patent Application Publication
(10) Pub. No.: US 2021/0266575 A1
(43) Pub. Date: Aug. 26, 2021

(54) VIDEO-BASED CODING OF POINT CLOUD OCCCUPANCY MAP

(71) Applicant: Telefonaktiebolaget LM Ericsson (publ), Stockholm (SE)

(72) Inventor: Lukasz LITWIC, Gdansk (PL)

(21) Appl. No.: 17/261,017

(22) PCT Filed: Jul. 12, 2019
(86) PCT No.: PCT/EP2019/068878

§ 371 Date: Jan. 17, 2021

Related U.S. Application Data
(60) Provisional application No. 62/699,831, filed on Jul. 18, 2018.

(51) Int. Cl. H04N 19/186; H04N 19/184; G06T 7/529

(52) U.S. Cl. CPC H04N 19/186; G06T 7/529; H04N 19/184

(57) ABSTRACT

A method by a transmitter for encoding a video image includes combining depth information and an occupancy map into a container in a video sequence. The video sequence including the depth information and the occupancy map is encoded. The encoded video sequence is transmitted to a receiver.

### TECHNICAL FIELD

This invention relates to video encoding. In particular, but not exclusively, this invention relates to the encoding of a video sequence to include an occupancy map in the encoded video sequence.

### BACKGROUND

This disclosure concerns point cloud data compression. Point clouds are data sets that can represent 3D visual data. Point clouds span several applications. Therefore, there is no uniform definition of point cloud data formats. A typical point cloud data set contains several points which are described by their spatial location (geometry) and one or several attributes. Most common attribute is color. For applications involving 3D modeling of humans and objects, color information is captured by standard video cameras. For other applications, such as automotive LiDAR scans, there could be no color information. Instead, for instance, a reflectance value would describe each point.

For immersive video applications, it is foreseen that point cloud data may be used to enhance immersive experience by allowing user to observe objects from all angles. Those objects would be rendered within immersive video scenes. For communication services, point cloud data could be used as a part of a holoportation system, where point cloud could be used to represent captured visualization of people on each side of a holoportation system.

In both main examples, point cloud data resembles traditional video in a sense that it captures a dynamically changing scene or object. Therefore, one attractive approach to deal with compression and transmission of point clouds has been based on leveraging existing video codec and transport infrastructure. This is a feasible approach given that a point cloud frame can be projected into one or several 2D pictures: geometry pictures and texture pictures. Several pictures per a single point cloud frame may be required to deal with occlusions or irregularities in captured point cloud data. Depending on application it may be required that point cloud geometry (spatial location of points) are reconstructed without any error.

In the current MPEG work on point cloud codec, such an approach is used. A single point cloud frame is projected into two geometry images and corresponding two texture images. One occupancy map frame defines which blocks (according to a predefined grid) are occupied with the actual projected information and which are empty. Additional information about projection is also provided. However, majority of information is in texture and geometry images and this is where most compression gains can be provided.

One of the approaches considered by MPEG treats geometry and texture as separate video sequences and uses separate video substreams to carry the information. The assumption is that the receiving decoder can decode all sessions and synchronize all collocated images for reconstruction.

There currently exist certain challenge(s). While the current arrangement is quite flexible since it allows extending into multiple streams, the approach based on two or more independent video streams comes with some potential disadvantages. Some of these disadvantages are discussed in U.S. Provisional Application No. 62/696,590 filed on Jul. 11, 2018, which described a way to frame-pack geometry and texture information in order to use a single bitstream and is incorporated by reference herein in its entirety.

For example, a disadvantage of extending into multiple streams is that, although geometry and texture are created as separate for reconstruction process, both are required to compose reconstructed point cloud. In addition, for a single point cloud frame, there are two geometry and two texture images created: the, so called, near projection and far projection. In total, in order to reconstruct a single point cloud frame, one requires to decode all four video images. It is possible to drop the far projection images and still be able to reconstruct a point cloud frame but at a loss of quality. For lossless coding, the images also contain a patch of data that represents points missed during the projection from 3D point cloud to 2D images.

When dealing with two or more video streams PCC decoder needs to be handling both video decoding dependencies in the underlying video streams as well as composition dependencies when reconstructing a point cloud frame. Video stream decoding dependency is handled by the underlying video codec while composition dependency is handled in the PCC decoder. If streams are independently generated, they may follow different coding order which may require extra handling in the decoder such as adding buffers to store partially reconstructed point cloud frames.

FIG. 1 illustrates a current point cloud bitstream arrangement. As depicted, geometry and texture video streams are stored sequentially. FIG. 1 shows the problem with existing solutions (based on multiple independent bitstreams). Competing dependencies between picture coding order and composition of reconstructed point cloud frames in solutions where no synchronization between independent encoders is provided. FIG. 1 depicts how composition dependencies which may conflict with decoding dependencies if coding order between two streams is not consistent. For a geometry stream, there is no picture reordering while for texture picture reordering follows hierarchical 7B structure. However, for point cloud reconstruction frames generated from the same source, point cloud frame must be used. Both decoders will output pictures in the original input order; however, the texture decoder will incur larger delay due to reordering in the decoder. This means that output pictures from the geometry decoder need to be buffered.

In the current proposal considered by the MPEG group (ISO/IEC JTC1/SC29/WG11 MPEG) the following problems can be identified:
There is no explicit mechanism to enforce synchronization of separate encoders (for geometry and texture) which can lead to different picture reordering for the two bitstreams.
Current substreams are GOF-interleaved. This means that unless both substreams are in synchronization during GOF there needs to be a provision for extra decoded pictures buffers.
Current arrangement incurs significant encoder delay where whole GOF of geometry picture requires to be coded before bitstream can be send. The only solution to support low delay is to shorten GOFs which may impact overall compression performance.
There is no mechanism how to signal to decoder or network device how discard frames from the stream e.g. to support trick modes.

Additionally, a disadvantage of the current solution for coding geometry and occupancy images is that they are both monochromatic. More specifically, only luma (Y signal) is used. In both cases, U&V signals are set to 0. Since most of deployments of video enabled devices and infrastructure supports carriage of video via YUV 4:2:0, 4:2:2 and 4:4:4 containers, these are also the formats used for storing geometry and occupancy map images.

### SUMMARY

Certain aspects of the present disclosure and their embodiments may provide solutions to these or other challenges. Specifically, according to certain embodiments, a video sequence is constructed by combining depth and occupancy maps together and placing them in a single YCbCr or YUV frame container. The solution proposes different arrangements for the occupancy map storage in CbCr or UV container.

According to certain embodiments, there is provided a method for encoding a video image. The method includes combining depth information and an occupancy map into a container in a video sequence. The video sequence including the depth information and the occupancy map are encoded. The encoded video sequence is output, for example transmitted to a receiver.

According to certain embodiments, there is provided a transmitter for encoding a video image. The transmitter includes memory storing instructions and processing circuitry configured to execute the instructions to cause the transmitter to combine depth information and an occupancy map into a container in a video sequence. The video sequence including the depth information and the occupancy map are encoded. The encoded video sequence is transmitted to a receiver.

According to certain embodiments, there is provided a method for decoding a video image. The method includes receiving an encoded video sequence. The encoded video sequence includes depth information and an occupancy map encoded in a container of the video sequence. The video sequence including the depth information and the occupancy map in the container of the video sequence is decoded.

According to certain embodiments, a receiver for decoding a video image includes memory storing instructions and processing circuitry configured to execute the instructions to cause the receiver to receive, from a transmitter, a video sequence. The encoded video sequence includes depth information and an occupancy map encoded in a container of the video sequence. The receiver decodes the video sequence including the depth information and the occupancy map in the container.

Certain embodiments may provide one or more of the following technical advantage(s). For example, a technical advantage may be that certain embodiments use a single video frame container for geometry and occupancy maps. This removes the need for two separate decoder instances and further handling of the decoded video for reconstruction purposes. Thus, a technical advantage may be that combining depth and occupancy maps together in a single YCbCr or YUV frame container may halve requirements for available video decoders.

As another example, a technical advantage may be that the impact on complexity is minimal since the current geometry images only use Y signal which U and V signals are not used but still processed by a video decoder.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a current point cloud bitstream arrangement;

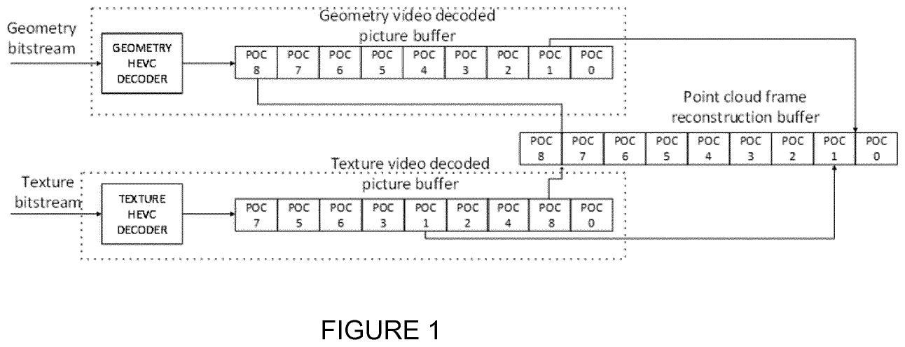

FIG. 2 illustrates 2D images generated from 3D to 2D projection for a single point cloud frame, according to certain embodiments;

FIG. 3 illustrates an example relationship between pixels for a 4:2:0 YUV container, wherein the occupancy map pixels are distributed to UV signals, according to certain embodiments;

FIG. 4 illustrates an example occupancy sub-image placed in a larger U or V signal container and signaling by offset, according to certain embodiments;

FIG. 5 illustrates an occupancy sub-image placed in a larger U or V signal container by spreading occupancy ma pixels, according to certain embodiments;

FIG. 6 illustrates an example scanning order for 4 top level pixels, according to certain embodiments;

FIG. 7 illustrates pixel_original_idc being applied to pixels across the picture, according to certain embodiments;

FIG. 8 illustrates an example system for video-based point cloud codec bitstream specification, according to certain embodiments;

FIG. 9 illustrates an example transmitter, according to certain embodiments;

FIG. 10 illustrates an example method by a transmitter for encoding a video image, according to certain embodiments;

FIG. 11 illustrates an example virtual computing device for encoding a video image, according to certain embodiments

FIG. 12 illustrates an example receiver, according to certain embodiments;

FIG. 13 illustrates an example method by a receiver for decoding a video image, according to certain embodiments; and

FIG. 14 illustrates an example virtual computing device for decoding a video image, according to certain embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Certain embodiments disclosed herein provide a solution to coding depth and occupancy maps by using a single video codec instance. This is achieved by constructing a single video sequence by combining depth and occupancy maps together into a YCbCr container, which may also be referred to herein as a YUV container.

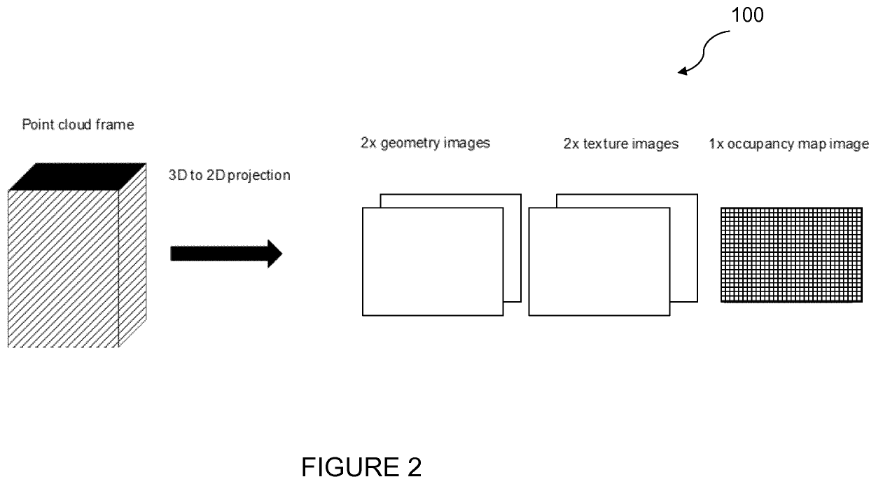

The video codec-based approach to point cloud coding is based on projecting a point cloud frame into several 2D images that can be coded with existing (or future) 2D video codecs. The advantage of such an approach is the existing deployment of 2D video codecs and video interfaces across media devices and infrastructures including network and cloud. The projection is done into three separate kinds of images: texture images which contains color information, depth (geometry) images which represents depth information about the projected points, and occupancy map image which contains binary information about which pixels in 2D images (texture and geometry) represent point cloud points. In the proposal considered by MPEG, there can be multiple texture and geometry images generated per a single point cloud frame while there is a single occupancy map image per point cloud frame. FIG. 2 illustrates 2D images 100 generated from 3D to 2D projection for a single point cloud frame.

### Texture Map Coding

The texture image contains color information which is represented by RGB values. Therefore, coding of texture images can leverage existing video codecs. For lossy coding, texture image can be converted to a YCbCr 4:2:0 container or YUV 4:2:0 container that is widely supported across several video coding standards such as HEVC, AVC.

### Depth Map Coding

In previous approaches, depth map is represented only by the luma signal (Y) but still it is carried in YUV container as this is the standard interface across most video enabled devices. In this case, U and V signals are set to zero (or another constant value) which means that effectively depth video signal is a monochromatic signal.

### Occupancy Map Coding

A similar approach applies to the occupancy map. Occupancy map is a binary map where pixel sample 1 means that corresponding sample in the collocated samples in the texture and depth images. When represented as a 2D image, occupancy map can have resolution equal to geometry and texture images or it can be down sampled with a scaling factor that is sent to the decoder. When scaling factor is larger than 1 then occupancy map is lossy coded (due to the downsampling process).

### Joint Geometry—Occupancy Image Construction

According to certain embodiments, a solution is proposed for constructing a joint geometry-occupancy image. The rationale for this is available pixels in the geometry image due to its monochrome nature. Therefore, the occupancy map can be fitted into the Cb and Cr signals of the YCbCr container or the U and V signals of the YUV container. Such an arrangement can be signaled to a decoder with a single flag send per sequence.

Image Construction with No Downsampling of Occupancy Map

Current PCC bitstream signals occupancy map precisions B0 and B1 determine occupancy map resolution as follows: (Width/B0)×(Height/B1) where Width and Height are dimensions of the geometry image.

Occupancy Map Placement in the YCbCr/YUV 4:4:4 Container

In the 4:4:4 container, dimensions of Cb and Cr images or U and V images are the same as for the Y image. Therefore, the occupancy map can fit in either Cb or Cr images in a YCbCr container or the U or V images in a YUV container. In case there is no subsampling of the occupancy map and its resolution equals the resolution of the geometry image, all pixels in Cb or Cr signal (or U or V signal) are populated. Either near or far layer geometry image Cb and Cr (or U and V) can be chosen as a container for the occupancy map image. However, since the far layer signal could be removed during bitstream operations (such as rate adaptation) the safest approach is to use the near-layer image.

Occupancy Map Placement in the YCbCr/YUV 4:2:0 Container

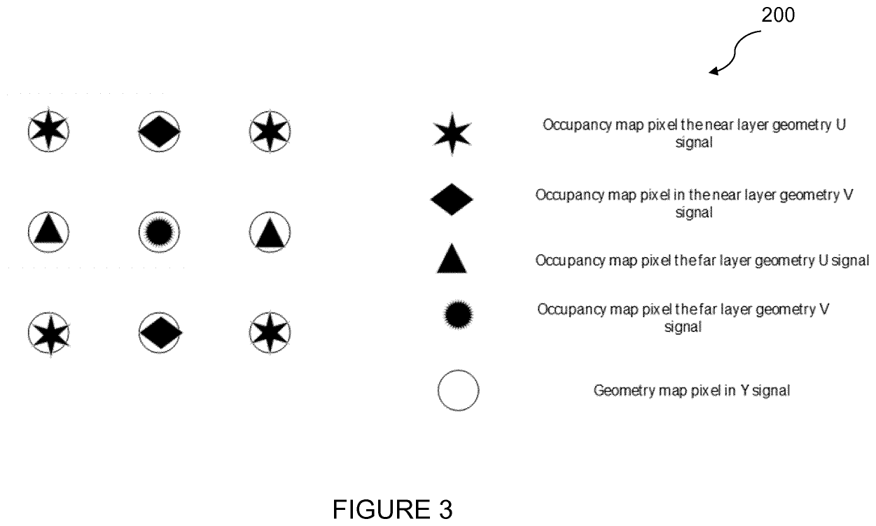

In the 4:2:0 container, the occupancy map will not fit a single Cb or Cr image or a single U or V image unless downsampling is applied. Thus, according to certain embodiments, when geometry is represented by a YCbCr 4:2:0 container or a YUV 4:2:0 container, downsampling may be applied. However, it still is possible to carry the full resolution occupancy map since there is only one occupancy map image per two geometry map images. As such, occupancy samples can be distributed between Cb and Cr images of the YCbCr container or U & V images of the YUV container from the two frames. FIG. 3 illustrates an example relationship 200 between pixels for a 4:2:0 YUV container, wherein the occupancy map pixels are distributed to UV signals, according to certain embodiments.

Image Construction with Sampling of Occupancy Map

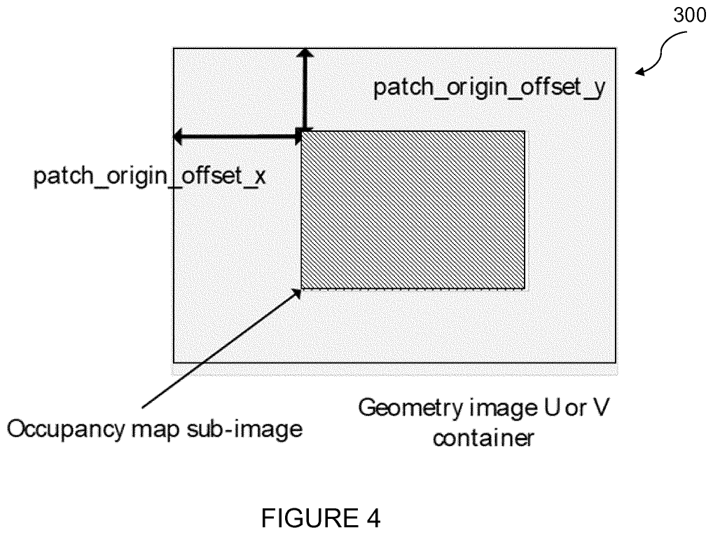

When downsampling of the occupancy map is applied, there may be two ways of representing pixels in a large container. The first approach is to place the occupancy image within a Cb or Cr image of a YCbCr container or U or V image of a YUV container. In case dimension of the occupancy image are smaller than of the Cb or Cr image or the U or V image, the offset values from the origin (top left pixel) are signaled. FIG. 4 illustrates an example occupancy sub-image 300 placed in a larger Cb or Cr signal container or U or V signal container and signaling by offset, according to certain embodiments.

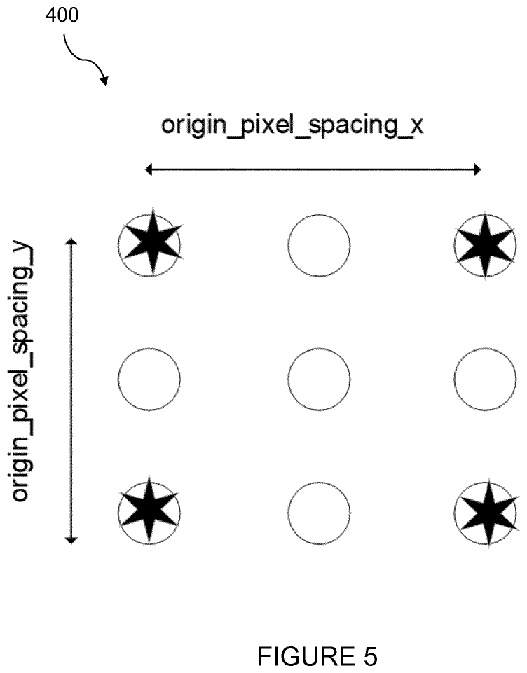

The second approach is to represent images as sparse images. In this way, occupancy map pixels are spread across the whole Cb and Cr picture (or U and V picture) while empty pixels are set to 0. FIG. 5 illustrates an occupancy sub-image 400 placed in a larger U or V signal container by spreading occupancy ma pixels, according to certain embodiments.

Combining in Single Bitstream with Texture Image

As described above, an approach to frame pack texture and geometry image was introduced in U.S. Provisional Application No. 62/696,590, which is incorporated herein by reference in its entirety. It follows from here that this approach can be combined with the single bitstream approach where the geometry image contains the occupancy map in the Cb or Cr containers (or U or V containers).

### Example Decoding Process of Occupancy Map Arrangement Syntax

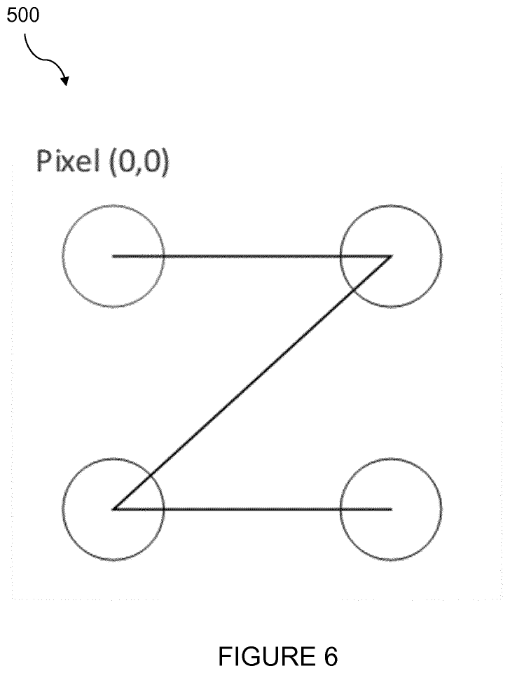

The decoding process for an arrangement offers two approaches described above. According to certain embodiments, the arrangement may be signaled in a bitstream:
occupancy_map_based_arrangement_idc—specifies which of the arrangements is signaled. 0 stands for patch-based arrangement and 1 signals pixel-based arrangement.
patch_originplane_idc—specifies which U or V signal carries occupancy map. 0—represents U signal (plane) for near layer frame, 1—represents V for near layer frame, 2—represents U signal for far layer frame, 3—represents V signal for far layer frame
patch_origin_offset_x—x offset in pixels in the origin signal from the top left corner.
patch_origin_offset_y—y offset in pixels in the origin signal from the top left corner.
origin_pixel_spacing_x—spacing between pixels in origin signal in the horizontal dimension
origin_pixel_spacing_y—spacing between pixels in origin signal in the vertical dimension
pixel_origin_idc[i]—specifies which U or V signal carries occupancy map. 0—represents U signal (plane) for near layer frame, 1—represents V for near layer frame, 2—represents U signal for far layer frame, 3—represents V signal for far layer frame.
origin_pixel_offset_x[i]—x offset in pixels in the origin signal from the top left corner.
origin_pixel_offset_y[i]—y offset in pixels in the origin signal from the top left corner.
i—iteration index that follows scanning order. FIG. 6 illustrates an example scanning order 500 for 4 top level pixels, according to certain embodiments. As depicted the scanning order begins with Pixel (0,0).

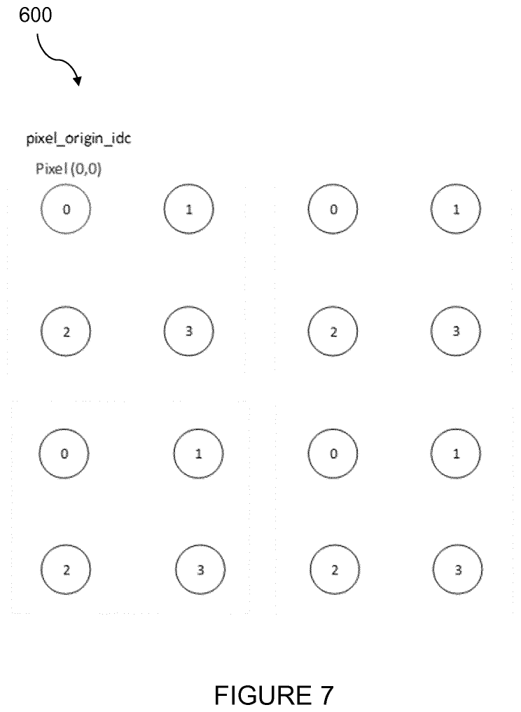

When processing across a whole frame values of pixel_origin_idc, origin_pixel_offset_x, origin_pixel_offset_y are used for determining the values for pixels in arranged in 2×2 blocks. FIG. 7 illustrates pixel_original_idc being applied to pixels across the picture 600, according to certain embodiments.

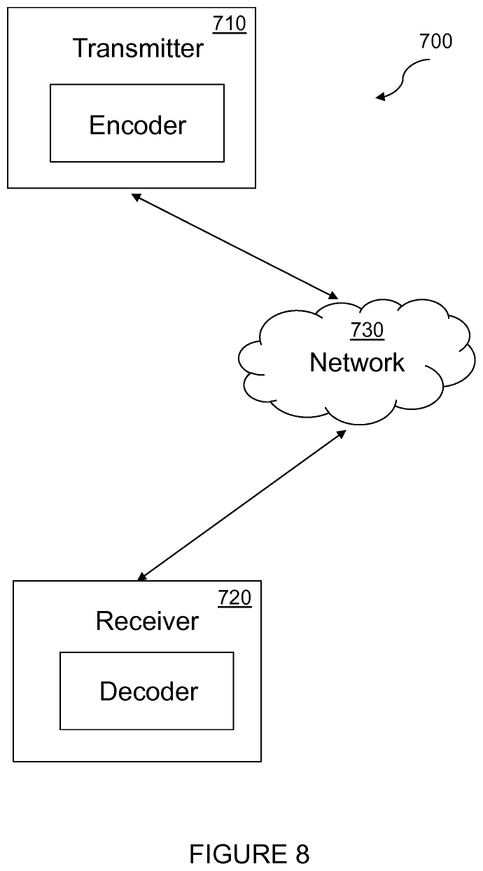

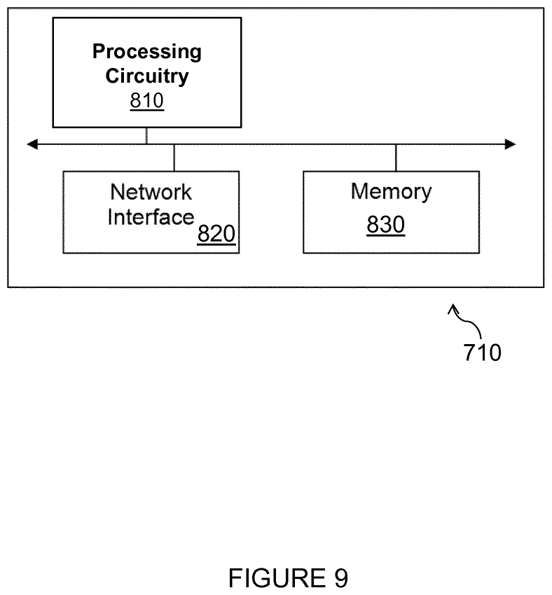

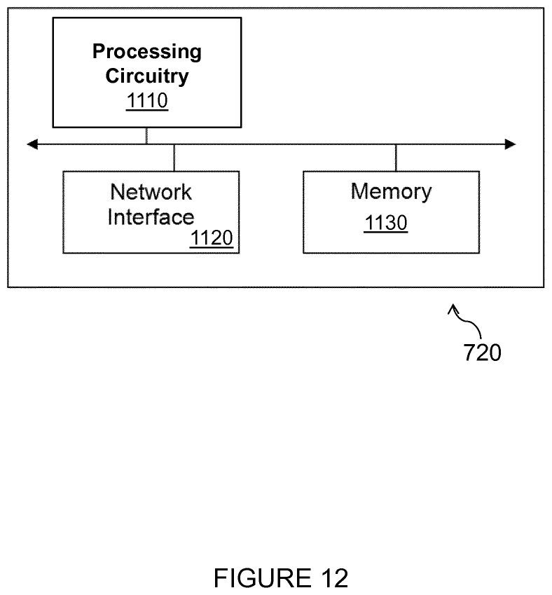

FIG. 8 illustrates an example system 700 for video-based point cloud codec bitstream specification, according to certain embodiments. System 700 includes one or more transmitters 710 and receivers 720, which communicate via network 730. Interconnecting network 730 may refer to any interconnecting system capable of transmitting audio, video, signals, data, messages, or any combination of the preceding. The interconnecting network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof. Example embodiments of transmitter 710 and receiver 720 are described in more detail with respect to FIGS. 9 and 12, respectively.

Although FIG. 8 illustrates a particular arrangement of system 700, the present disclosure contemplates that the various embodiments described herein may be applied to a variety of networks having any suitable configuration. For example, system 700 may include any suitable number of transmitters 710 and receivers 720, as well as any additional elements suitable to support communication between such devices (such as a landline telephone). In certain embodiments, transmitter 710 and receiver 720 use any suitable radio access technology, such as long-term evolution (LTE), LTE-Advanced, UMTS, HSPA, GSM, cdma2000, WiMax, WiFi, another suitable radio access technology, or any suitable combination of one or more radio access technologies. For purposes of example, various embodiments may be described within the context of certain radio access technologies. However, the scope of the disclosure is not limited to the examples and other embodiments could use different radio access technologies.

FIG. 9 illustrates an example transmitter 710, according to certain embodiments. As depicted, the transmitter 710 includes processing circuitry 810 (e.g., which may include one or more processors), network interface 820, and memory 830. In some embodiments, processing circuitry 810 executes instructions to provide some or all of the functionality described above as being provided by the transmitter, memory 830 stores the instructions executed by processing circuitry 810, and network interface 820 communicates signals to any suitable node, such as a gateway, switch, router, Internet, Public Switched Telephone Network (PSTN), etc.

Processing circuitry 810 may include any suitable combination of hardware and software implemented in one or more modules to execute instructions and manipulate data to perform some or all of the described functions of the transmitter. In some embodiments, processing circuitry 810 may include, for example, one or more computers, one or more central processing units (CPUs), one or more microprocessors, one or more applications, and/or other logic.

Memory 830 is generally operable to store instructions, such as a computer program, software, an application including one or more of logic, rules, algorithms, code, tables, etc. and/or other instructions capable of being executed by a processor. Examples of memory 830 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 820 is communicatively coupled to processing circuitry 810 and may refer to any suitable device operable to receive input for the transmitter, send output from the transmitter, perform suitable processing of the input or output or both, communicate to other devices, or any combination of the preceding. Network interface 820 may include appropriate hardware (e.g., port, modem, network interface card, etc.) and software, including protocol conversion and data processing capabilities, to communicate through a network.

Other embodiments of the transmitter may include additional components beyond those shown in FIG. 9 that may be responsible for providing certain aspects of the transmitter's functionality, including any of the functionality described above and/or any additional functionality (including any functionality necessary to support the solution described above).

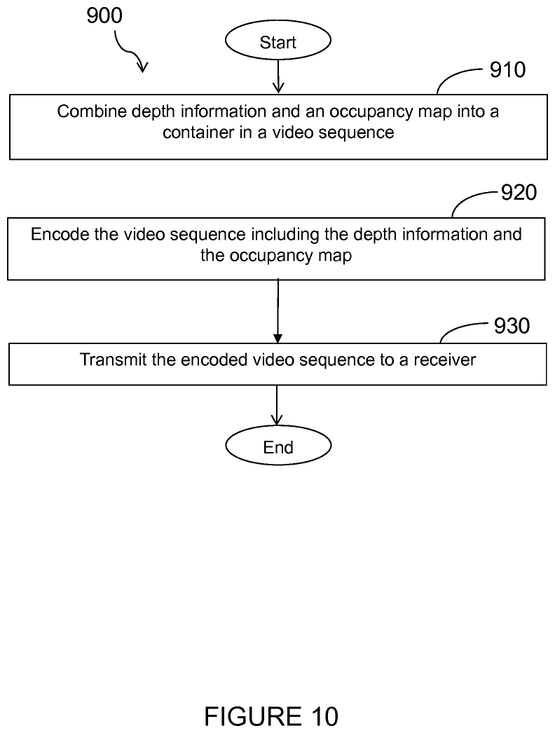

FIG. 10 illustrates an example method 900 by a transmitter 710 for encoding a video image, according to certain embodiments. The method begins at step 910 when the transmitter 710 combines depth information and an occupancy map into a container in a video sequence. At step 920, the transmitter encodes the video sequence including the depth information and the occupancy map. At step 930, the transmitter 710 transmits the encoded video sequence to a receiver. In a particular embodiment, the encoded video sequence is transmitted in a single video bitstream.

In a particular embodiment, the occupancy map includes binary information about which pixels in the depth information and a texture image represent a point cloud point.

In a particular embodiment, the depth information may include at least a first projection, which may include a near plane projection or a far plane projection.

In another particular embodiment, the depth information may include a first projection and a second projection. The first projection may include a near plane projection and the second projection may include a far plane projection.

In a particular embodiment, the container is a YUV container. For example, the YUV container may include a 4:4:4 container, a 4:2:2 container, or a 4:2:0 container. In a particular embodiment, the depth information may be carried in a Y signal of the container and the occupancy map may be carried in at least one of the U and V signals of the container. In another embodiment, the occupancy map may be carried in both the U and V signals of the container. In still another embodiment, downsampling may be applied by the transmitter 710, and the occupancy map may be carried in one of the U and V signals of the container.

In a particular embodiment, the container is a YCbCr container. For example, the YCbCr container may include a 4:4:4 container, a 4:2:2 container, or a 4:2:0 container. In a particular embodiment, the depth information may be carried in a Y signal of the container and the occupancy map may be carried in at least one of the Cb and Cr signals of the container. In another embodiment, the occupancy map may be carried in both the Cb and Cr signals of the container. In still another embodiment, downsampling may be applied by the transmitter 710, and the occupancy map may be carried in one of the Cb and Cr signals of the container.

In a particular embodiment, the transmitter 710 may signal, to the receiver, origin plane information indicating at least one signal of the container that is carrying the occupancy map.

In a particular embodiment, the occupancy map may be smaller than the signal carrying the occupancy map, and the transmitter may signal at least one offset value measured from an original pixel to the receiver. In a particular embodiment, the at least one offset value includes a first offset value in an x direction and a second offset value in a y direction.

In another particular embodiment, the occupancy map may be smaller than the U or V signal carrying the occupancy map, and the transmitter 710 may spread a plurality of pixels of the occupancy map across at least one signal of the container. Additionally, in a particular embodiment, the transmitter 710 may signal, to the receiver 720, the at least one spacing value. In a particular embodiment, the at least one spacing value includes a first spacing value in a horizontal direction and a second spacing value in a vertical direction.

Additionally, or alternatively, the transmitter 710 may signal information indicating whether a patch-based arrangement or a pixel-based arrangement is used for the occupancy map.

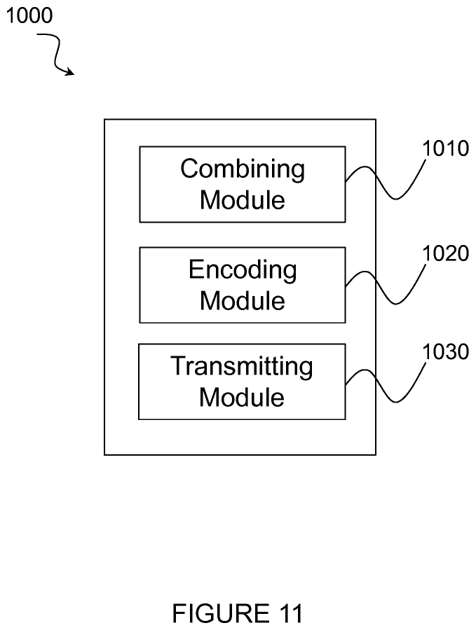

In certain embodiments, the method for encoding a video image as described above may be performed by a computer networking virtual apparatus. FIG. 11 illustrates an example virtual computing device 1000 for encoding a video image, according to certain embodiments. In certain embodiments, virtual computing device 1000 may include modules for performing steps similar to those described above with regard to the method illustrated and described in FIG. 10. For example, virtual computing device 1000 may include a combining module 1010, an encoding module 1020, a transmitting module 1030, and any other suitable modules for encoding and transmitting a video image. In some embodiments, one or more of the modules may be implemented using processing circuitry 810 of FIG. 9. In certain embodiments, the functions of two or more of the various modules may be combined into a single module.

The combining module 1010 may perform the combining functions of virtual computing device 1000. For example, in a particular embodiment, combining module 1010 may combine depth information and an occupancy map into a container in a video sequence.

The encoding module 1020 may perform the encoding functions of virtual computing device 1000. For example, in a particular embodiment, encoding module 1020 may encode the video sequence including the depth information and the occupancy map.

The transmitting module 1030 may perform the transmitting functions of virtual computing device 1000. For example, in a particular embodiment, transmitting module 1030 may transmit the encoded video sequence to a receiver 720.

Other embodiments of virtual computing device 1000 may include additional components beyond those shown in FIG. 11 that may be responsible for providing certain aspects of the transmitter functionality, including any of the functionality described above and/or any additional functionality (including any functionality necessary to support the solutions described above). The various different types of transmitters 710 may include components having the same physical hardware but configured (e.g., via programming) to support different radio access technologies, or may represent partly or entirely different physical components.

FIG. 12 illustrates an example receiver 720, according to certain embodiments. As depicted, receiver 720 includes processing circuitry 1110 (e.g., which may include one or more processors), network interface 1120, and memory 1130. In some embodiments, processing circuitry 1110 executes instructions to provide some or all of the functionality described above as being provided by the receiver, memory 1130 stores the instructions executed by processing circuitry 1110, and network interface 1120 communicates signals to any suitable node, such as a gateway, switch, router, Internet, Public Switched Telephone Network (PSTN), etc.

Processing circuitry 1110 may include any suitable combination of hardware and software implemented in one or more modules to execute instructions and manipulate data to perform some or all of the described functions of the transmitter. In some embodiments, processing circuitry 1110 may include, for example, one or more computers, one or more central processing units (CPUs), one or more microprocessors, one or more applications, and/or other logic.

Memory 1130 is generally operable to store instructions, such as a computer program, software, an application including one or more of logic, rules, algorithms, code, tables, etc. and/or other instructions capable of being executed by a processor. Examples of memory 1130 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 1120 is communicatively coupled to processing circuitry 1110 and may refer to any suitable device operable to receive input for the receiver, send output from the receiver, perform suitable processing of the input or output or both, communicate to other devices, or any combination of the preceding. Network interface 1120 may include appropriate hardware (e.g., port, modem, network interface card, etc.) and software, including protocol conversion and data processing capabilities, to communicate through a network.

Other embodiments of the receiver may include additional components beyond those shown in FIG. 12 that may be responsible for providing certain aspects of the receiver's functionality, including any of the functionality described above and/or any additional functionality (including any functionality necessary to support the solution described above).

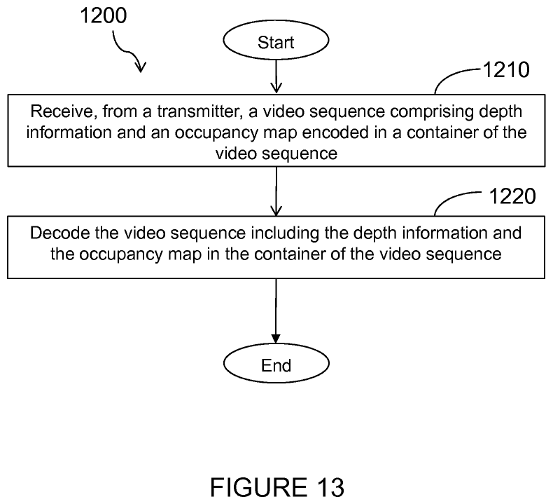

FIG. 13 illustrates an example method 1200 by a receiver 720 for decoding a video image, according to certain embodiments. The method begins at step 1210 when the receiver receives, from a transmitter, a video sequence that includes depth information and an occupancy map encoded in a container of the video sequence. In a particular embodiment, the encoded video sequence may be received in a single video bitstream. At step 1220, the receiver decodes the video sequence including the depth information and the occupancy map in the container of the video sequence.

In a particular embodiment, the occupancy map includes binary information about which pixels in the depth information and a texture image represent a point cloud point.

In a particular embodiment, the depth information includes at least a first projection, which may include a near plane projection or a far plane projection.

In another particular embodiment, the depth information includes a first projection and a second projection. The first projection may include a near plane projection, and the second projection may include a far plane projection.

In a particular embodiment, the container is a YUV container. For example, the YUV container may include a 4:4:4 container, a 4:2:2 container, or a 4:2:0 container. In a particular embodiment, the depth information may be carried in a Y signal of the container and the occupancy map may be carried in at least one of the U and V signals of the container. In another embodiment, the occupancy map may be carried in both the U and V signals of the container. In still another embodiment, the YUV container may include a 4:2:0 container and downsampling may be applied by the transmitter. The occupancy map may then be carried in one of the U and V signals of the container.

In a particular embodiment, the container is a YCbCr container. For example, the YCbCr container may include a 4:4:4 container, a 4:2:2 container, or a 4:2:0 container. In a particular embodiment, the depth information may be carried in a Y signal of the container and the occupancy map may be carried in at least one of the Cb and Cr signals of the container. In another embodiment, the occupancy map may be carried in both the Cb and Cr signals of the container. In still another embodiment, downsampling may be applied by the transmitter 710, and the occupancy map may be carried in one of the Cb and Cr signals of the container.

In a particular embodiment, the receiver 720 may receive, from the transmitter 710, origin plane information indicating at least one signal of the container that is carrying the occupancy map.

In a particular embodiment, the occupancy map may be smaller than the signal carrying the occupancy map, and the receiver may receive at least one offset value measured from an original pixel from the transmitter. In a particular embodiment, the at least one offset value includes a first offset value in an x direction and a second offset value in a y direction.

In another particular embodiment, the occupancy map may be smaller than the signal carrying the occupancy map, and the plurality of pixels of the occupancy map may be spread across at least one signal of the container. For example, in a further particular embodiment, receiver 720 may receive at least one spacing value from the transmitter 710. In a particular embodiment, the at least one spacing value includes a first spacing value in a horizontal direction and a second spacing value in a vertical direction.

Additionally, or alternatively, in a particular embodiment the receiver may receive information indicating whether a patch-based arrangement or a pixel-based arrangement is used for the occupancy map.

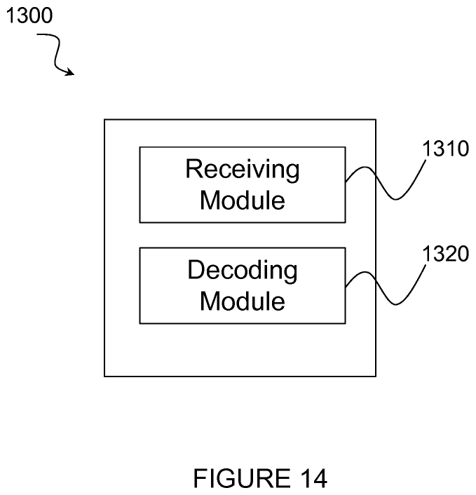

In certain embodiments, the method for decoding a video image as described above may be performed by a computer networking virtual apparatus. FIG. 14 illustrates an example virtual computing device 1300 for decoding a video image, according to certain embodiments. In certain embodiments, virtual computing device 1300 may include modules for performing steps similar to those described above with regard to the method illustrated and described in FIG. 13. For example, virtual computing device 1300 may include a receiving module 1310, a decoding module 1320, and any other suitable modules for decoding a video image. In some embodiments, one or more of the modules may be implemented using processing circuitry 1110 of FIG. 12. In certain embodiments, the functions of two or more of the various modules may be combined into a single module.

The receiving module 1310 may perform the receiving functions of virtual computing device 1300. For example, in a particular embodiment, receiving module 1310 may receive, from a transmitter 710, a video sequence that includes depth information and an occupancy map encoded in a container of the video sequence.

The decoding module 1320 may perform the decoding functions of virtual computing device 1300. For example, in a particular embodiment, decoding module 1320 may decode the video sequence including the depth information and the occupancy map in the container of the video sequence.

Other embodiments of virtual computing device 1300 may include additional components beyond those shown in FIG. 14 that may be responsible for providing certain aspects of the receiver functionality, including any of the functionality described above and/or any additional functionality (including any functionality necessary to support the solutions described above). The various different types of receivers 720 may include components having the same physical hardware but configured (e.g., via programming) to support different radio access technologies, or may represent partly or entirely different physical components.

### Example Embodiments

Embodiment 1. A method by a transmitter for encoding a video image, the method comprising:

combining a depth information and an occupancy map into a container in a video sequence;

encoding the video sequence including the depth information and the occupancy map; and

transmitting, to a receiver, the encoded video sequence.

Embodiment 2. The method of embodiment 1, wherein the occupancy map comprises binary information about which pixels in the depth information and a texture image represent a point cloud point.
Embodiment 3. The method of any one of embodiments 1 to 2, wherein the depth information is a near plane projection.
Embodiment 4. The method of any one of embodiments 1 to 2, wherein the depth information is a far plane projection.
Embodiment 5. The method of any one of embodiments 1 to 4, wherein:

the container comprises a YUV container,

the depth information is carried in a Y signal of the container, and

the occupancy map is carried in at least one of the U and V signals of the container.

Embodiment 6. The method of embodiment 5, wherein the YUV container comprises a 4:4:4 container, a 4:2:2 container, or a 4:2:0 container.
Embodiment 7. The method of any one of embodiments 5 to 6, wherein the occupancy map is carried in both the U and V signals of the container.
Embodiment 8. The method of any one of embodiments 5 to 6, wherein the method further comprises applying downsampling, and the occupancy map is carried in one of the U and V signals of the container.
Embodiment 9. The method of any one of embodiments 5 to 8, wherein:

the occupancy map is smaller than the U or V signal carrying the occupancy map, and

the method further comprises signaling at least one offset value measured from an original pixel to the receiver.

Embodiment 10. The method of embodiment 9, wherein the at least one offset value comprises:

a first offset value in an x direction, and

a second offset value in a y direction.

Embodiment 11. The method of any one of embodiments 5 to 8, wherein:

the occupancy map is smaller than the U or V signal carrying the occupancy map, and

the method further comprises:
spreading a plurality of pixels of the occupancy map across at least one of the U signal and the V signal, and
signaling, to the receiver, at least one spacing value.
   Embodiment 12. The method of embodiment 11, wherein the at least one spacing value comprises:

a first spacing value in a horizontal direction, and

a second spacing value in a vertical direction.

Embodiment 13. The method of any one of embodiments 5 to 12, further comprising:

signaling, to the receiver, origin plane information indicating which of the U signal or the V signal that is carrying the occupancy map.

Embodiment 14. The method of any one of embodiments 1 to 13, further comprising:

signaling, to the receiver, information indicating whether a patch-based arrangement or a pixel-based arrangement is used for the occupancy map.

Embodiment 15. The method of any one of embodiments 1 to 14, wherein the encoded video sequence is transmitted in a single video bitstream.
Embodiment 16. A transmitter for encoding a video image, the encoder comprising:

memory storing instructions; and

processing circuitry configured to execute the instructions to cause the encoder to perform any one of embodiments 1 to 15.

Embodiment 17. A computer program comprising instructions which when executed on a computer perform any of the methods of embodiments 1 to 15.
Embodiment 18. A computer program product comprising computer program, the computer program comprising instructions which when executed on a computer perform any of the methods of embodiments 1 to 15.
Embodiment 19. A non-transitory computer readable medium storing instructions which when executed by a computer perform any of the methods of embodiments 1 to 15.
Embodiment 20. A method by a receiver for decoding a video image, the method comprising:

receiving, from a transmitter, a video sequence, the encoded video sequence comprising depth information and an occupancy map encoded in a container of the video sequence;

decoding the video sequence including the depth information and the occupancy map in the container of the video sequence.

Embodiment 21. The method of embodiment 20, wherein the occupancy map comprises binary information about which pixels in the depth information and a texture image represent a point cloud point.
Embodiment 22. The method of any one of embodiments 20 to 21, wherein the depth information is a near plane projection.
Embodiment 23. The method of any one of embodiments 20 to 21, wherein the depth information is a far plane projection.
Embodiment 24. The method of any one of embodiments 20 to 23, wherein:

the container comprises a YUV container,

the depth information is carried in a Y signal of the container, and

the occupancy map is carried in at least one of the U and V signals of the container.

Embodiment 25. The method of embodiment 24, wherein the YUV container comprises a 4:4:4 container, a 4:2:2 container, or a 4:2:0 container.
Embodiment 26. The method of any one of embodiments 24 to 25, wherein the occupancy map is carried in both the U and V signals of the container.
Embodiment 27. The method of any one of embodiments 24 to 25, wherein:

downsampling has been applied, and

the occupancy map is carried in one of the U and V signals of the container.

Embodiment 28. The method of any one of embodiments 24 to 27, wherein:

the occupancy map is smaller than the U or V signal carrying the occupancy map, and

the method further comprises receiving, from the transmitter, at least one offset value measured from an original pixel to the receiver.

Embodiment 29. The method of embodiment 28, wherein the at least one offset value comprises:

a first offset value in an x direction, and

a second offset value in a y direction.

Embodiment 30. The method of any one of embodiments 24 to 27, wherein:

the occupancy map is smaller than the U or V signal carrying the occupancy map, and

a plurality of pixels of the occupancy map are spread across at least one of the U signal and the V signal, and

the method further comprises receiving, from the transmitter, at least one spacing value.

Embodiment 31. The method of embodiment 30, wherein the at least one spacing value comprises:

a first spacing value in a horizontal direction, and

a second spacing value in a vertical direction.

Embodiment 32. The method of any one of embodiments 24 to 31, further comprising:

receiving, from the transmitter, origin plane information indicating which of the U signal or the V signal that is carrying the occupancy map.

Embodiment 33. The method of any one of embodiments 20 to 32, further comprising:

receiving, from the transmitter, information indicating whether a patch-based arrangement or a pixel-based arrangement is used for the occupancy map.

Embodiment 34. The method of any one of embodiments 20 to 33, wherein the encoded video sequence is received in a single video bitstream.
Embodiment 35. A receiver for decoding a video image, the decoder comprising:

memory storing instructions; and

processing circuitry configured to execute the instructions to cause the receiver to perform any one of embodiments 20 to 34.

Embodiment 36. A computer program comprising instructions which when executed on a computer perform any of the methods of embodiments 20 to 34.
Embodiment 37. A computer program product comprising computer program, the computer program comprising instructions which when executed on a computer perform any of the methods of embodiments 20 to 34.
Embodiment 36. A non-transitory computer readable medium storing instructions which when executed by a computer perform any of the methods of embodiments 20 to 34.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1. A method for encoding a video image, the method comprising:
combining a depth information and an occupancy map into a container in a video sequence;
encoding the video sequence including the depth information and the occupancy map; and
outputting the encoded video sequence.

2. The method of claim 1, wherein the occupancy map comprises binary information about which pixels in the depth information and a texture image represent a point cloud point.

3-5. (canceled)

6. The method of claim 1, wherein:
the container comprises a YCbCr container;
the depth information is carried in a Y signal of the container; and
the occupancy map is carried in at least one of Cb and Cr signals of the container.

7-18. (canceled)

19. A transmitter for encoding a video image, the transmitter comprising:
memory storing instructions; and
processing circuitry configured to execute the instructions to cause the transmitter to:
combine a depth information and an occupancy map into a container in a video sequence;
encode the video sequence including the depth information and the occupancy map; and
transmit, to a receiver, the encoded video sequence.

20. The transmitter of claim 19, wherein the occupancy map comprises binary information about which pixels in the depth information and a texture image represent a point cloud point.

21-23. (canceled)

24. The transmitter of claim 19, wherein:
the container comprises a YCbCr container,
the depth information is carried in a Y signal of the container, and
the occupancy map is carried in at least one of Cb and Cr signals of the container.

25-36. (canceled)

37. A method for decoding an encoded video sequence, the method comprising:
receiving an encoded video sequence, the encoded video sequence comprising depth information and an occupancy map encoded in a container of the video sequence; and
decoding the encoded video sequence including the depth information and the occupancy map in the container of the video sequence.

38. The method of claim 37, wherein the occupancy map comprises binary information indicative of which pixels in the depth information and a texture image represent a point cloud point.

39-41. (canceled)

42. The method of claim 37, wherein:
the container comprises a YCbCr container,
the depth information is carried in a Y signal of the container, and
the occupancy map is carried in at least one of Cb and Cr signals of the container.

43. The method of claim 42, wherein the YCbCr container comprises a 4:4:4 container, a 4:2:2 container, or a 4:2:0 container.

44. (canceled)

45. The method of claim 42, wherein:
downsampling has been applied, and
the occupancy map is carried in at least one of the Cb and Cr signals of the container.

46. The method of claim 45, further comprising:
receiving, from the transmitter, origin plane information, and
wherein the origin plane information indicates at least one signal of the container that is carrying the occupancy.

47-54. (canceled)

55. A receiver for decoding an encoded video sequence, the receiver comprising:
memory storing instructions; and
processing circuitry configured to execute the instructions to cause the receiver to:
receive, from a transmitter, an encoded video sequence, the encoded video sequence comprising depth information and an occupancy map encoded in a container of the video sequence; and
decode the encoded video sequence including the depth information and the occupancy map in the container of the video sequence.

56. The receiver of claim 55, wherein the occupancy map comprises binary information about which pixels in the depth information and a texture image represent a point cloud point.

57-59. (canceled)

60. The receiver of claim 55, wherein:
the container comprises a YCbCr container,
the depth information is carried in a Y signal of the container, and
the occupancy map is carried in at least one of Cb and Cr signals of the container.

61. The receiver of claim 60, wherein the YCbCr container comprises a 4:4:4 container, a 4:2:2 container, or a 4:2:0 container.

62-63. (canceled)

64. The receiver of claim 61, wherein the processing circuitry is configured to execute the instructions to cause the receiver to:
receive, from the transmitter, origin plane information, and
wherein the origin plane information indicates at least one signal of the container that is carrying the occupancy map.

65-72. (canceled)
